(19) United States
(12) Patent Application Publication
(10) Pub. No.: US 2024/0189742 A1
(43) Pub. Date: Jun. 13, 2024

(54) LIQUID CONTAINMENT AND FILTRATION DEVICE

(71) Applicant: YARDNEY WATER MANAGEMENT SYSTEMS INC., Riverside, CA (US)

(72) Inventor: Chris PHILLIPS, Riverside, CA (US)

(73) Assignee: YARDNEY WATER MANAGEMENT SYSTEMS INC., Riverside, CA (US)

(21) Appl. No.: 18/532,484

(22) Filed: Dec. 7, 2023

Related U.S. Application Data
(60) Provisional application No. 63/430,772, filed on Dec. 7, 2022.

(51) Int. Cl. B01D 24/10; B01D 24/42

(52) U.S. Cl. CPC B01D 24/105; B01D 24/42; B01D 2101/04

(57) ABSTRACT

A filtration system for filtering liquid. The filtration system includes a vessel and a filtering media within the vessel. The vessel contains an underdrain at the bottom to drain the filtered liquid coming in from the top of the vessel. A drain port is provided at the bottom of the vessel in order to provide ease of access for maintenance and replacement of the underdrain. The system disclosed provides ease of maintenance thus aiding in the prevention of corrosion.

### CROSS-REFERENCE TO RELATED PATENT APPLICATIONS

This application claims priority to and the benefit of U.S. Provisional Patent Application No. 63/430,772 filed Dec. 7, 2022 which is incorporated by reference herein in its entirety.

### BACKGROUND OF THE INVENTION

This application relates to a device and system for containing and filtering liquid. Specifically, a vessel containing a sand media water filter with drain ports and a removable underdrain. These filtering vessels are typically used in agriculture irrigation, golf and turf and industrial processes

Microbiologically Induced Corrosion (MIC) is a corrosive process initiated by the metabolic activities of microorganisms. This phenomenon poses a substantial threat to the structural integrity of vessels employed across diverse industries. MIC has the potential to generate pinhole leaks in the walls of vessels, particularly steel tanks, accentuating the need for effective prevention strategies. These vessels, when utilized as a sand media filter, also typically include an underdrain. Sand media filters remove suspended solids from liquids for filtration purposes. This underdrain is critical because it facilitates the drainage or removal of the liquid within the vessels. MIC may also damage components in the underdrain. In high salinity applications pinhole leaks may arise even faster and in as short as 12 months. Recognizing the need to mitigate MIC, there is a growing demand for preventive measures in order to safeguard the integrity and longevity of vessels in many applications.

Prior solutions are restrictive on maintenance, life cycle of the product. They also create waste of energy and water due to pinhole leaks. The current disclosed solution provides an efficient and cost-effective system to eliminate the potential for pinhole leaks on virtually any water source and provide a streamlined and time-efficient approach to maintenance for the aforementioned vessels.

### BRIEF DESCRIPTION OF THE DRAWINGS

FIG. 1 shows an exemplary vessel.

FIG. 2 shows the interior of the exemplary vessel shown in FIG. 1.

FIG. 3 shows the interior of the exemplary vessel shown in FIG. 1.

### DETAILED DESCRIPTION OF THE INVENTION

The particulars shown herein are by way of example and for purposes of illustrative discussion of the disclosed embodiments and are presented to provide a readily understood description of the principles and conceptual aspects. In this regard, no attempt is made to show structural details in more detail than is necessary for a fundamental understanding, and the description taken together with the drawings make apparent to those skilled in the art how the disclosed devices and methods may be embodied in practice.

As stated above, microbiological induced corrosion within can create pinhole leaks within the vessel. Additionally, the invention may include a removable underdrain which is accessed through one or more drain ports to allow the user to inspect inside the vessel and replace the underdrain if needed. Furthermore, a protective barrier may be provided on the interior of the vessel such that the barrier is between the vessel walls and the water to prevent any potential of corrosion.

In one embodiment, a filtering system configured to filter liquid for external use is disclosed. The filtering system comprising a vessel configured to hold a filtering media, said vessel having a wall defining an inner volume, wherein the vessel includes an inlet and an outlet. A removable underdrain located on a lower section of the vessel. The underdrain is disposed within the inner volume and coupled to the outlet of the vessel. A pair of diametrically opposed drain ports configured for emptying the vessel of the filtering media and configured to provide access to the removable underdrain for replacement.

In one embodiment, a filtering system configured to filter liquid for external use is disclosed. The filtering system comprising a vessel having an upper, middle, and lower section The vessel configured to hold a filtering media and having a wall defining an inner volume, wherein the vessel includes an inlet at the upper section and an outlet at the lower section. A removable underdrain located on the lower section of the vessel. The underdrain is disposed within the inner volume and coupled to the outlet of the vessel. At least one drain port configured for emptying the vessel of the filtering media and configured to provide access to the removable underdrain for replacement. The vessel is absent of a side manway at a middle section of the vessel.

In one embodiment, a filtering system configured to filter liquid for external use is disclosed. The filtering system comprising a suspended vessel configured to hold a filtering media, said vessel having a wall defining an inner volume, wherein the vessel includes an inlet and an outlet. The vessel is configured to be suspended from a ground via at least one vessel support beam, and wherein the outlet is on the lowest section of the vessel at a centerline of the vessel. A removable underdrain disposed within the inner volume and coupled to the outlet of the vessel. A pair of diametrically opposed drain ports configured for emptying the vessel of the filtering media and configured to provide access to the removable underdrain for replacement.

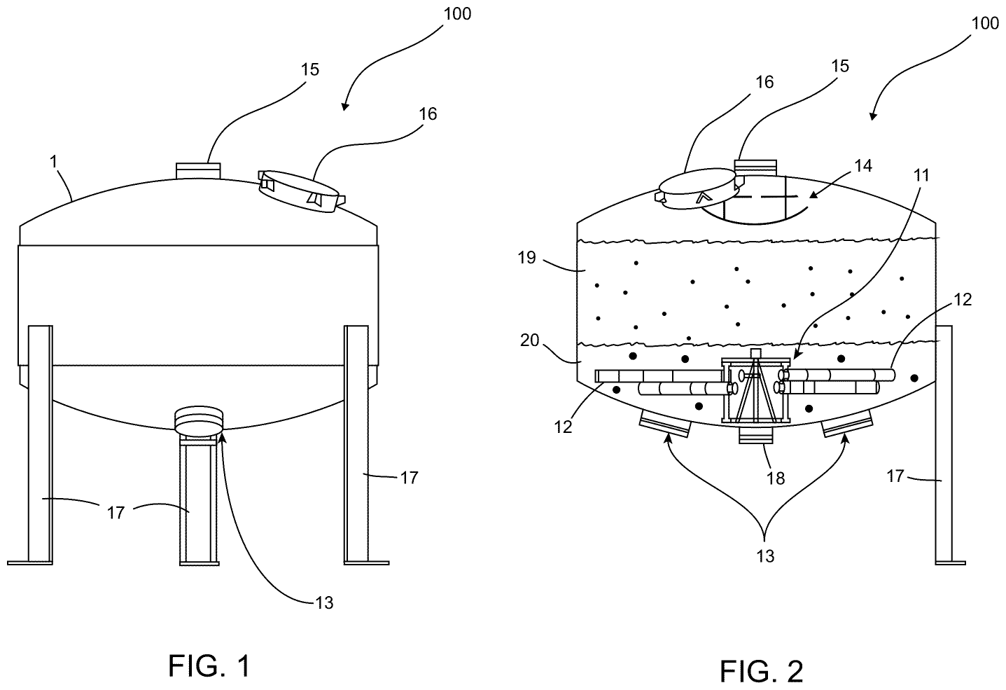

Referring to FIG. 1, a filtering system 100 comprising a vessel 1 is shown. The vessel may include at least one drain port 13. The vessel 1 may be suspended and linked to a number of other vessels containing the same structure. The vessel includes an upper section 2, middle section 3, and lower section 4. The vessel's width may be greater than the vessel's height. The vessel 1 may also be suspended via vessel support legs (or beam) 17. The vessel may be cylindrical, although other shapes may be utilized. The vessel also includes an inlet 15 and an outlet 18. The inlet 15 may be located on the top most part of the upper section 2. While the outlet 18 is located on the bottom most part of the lower section 4. The inlet 15 and outlet 18 may be located on the centerline of the vessel 1. The drain ports 13 may be offset from the centerline of the vessel. The vessel is preferably a stainless steel vessel.

Referring to FIGS. 2 & 3, the vessel 1 may be a filter that includes one or more filtration media 19 and 20. For example, in one embodiment, the vessel may be a sand media filter where 19 is the sand media and the 20 is gravel. Sand media filters are vessels that are designed for filtration for the removal of organic and inorganic suspended solids. These filters work by forcing water through one or more of vessels filled with a specific type of sand, which traps contaminants as the water flows through the media. These vessels may be connected in series or in parallel to a source of water. To maintain their effectiveness, the vessels are regularly back-flushed with filtered water to remove accumulated particles from the media. As shown in FIG. 2 an underdrain 11 is shown comprising one or more lateral sections 12. Laterals 12 may extend from the main body of the underdrain 11 and is fluidly connected to the main body of the underdrain 11. The underdrain are configured to aid in the draining and the backwashing procedure via the laterals. Underdrains for sand media filters are essential components that play an important role in ensuring the optimal functionality of sand media filtration systems. They are designed to support the sand media and ensure uniform distribution of water during backwashing. The underdrain system also helps in preventing channeling and ensures that the water flows evenly through the filter media bed during the filtration process. Typically, a sand media filter is subject to high pressures and thus the vessel may be configured to withstand high pressures.

The underdrain 11 is configured to be easily removable. The underdrain is accessible through either of the drain ports 13. If the underdrain becomes fouled due to calcium or damaged it will create operating problems including high pressure differential, lack of water flow which results in channeling of the media bed, higher operating costs and increased maintenance of the equipment. Drain ports 13 allows access to the removable underdrain without the additional cost of a side manway. The absence of a side manway (i.e. no ports on the sides or middle sections of the vessel) improves the structure and cost of the tank. The vessel may also include an upper manway 16. In one embodiment, there is at least a pair of diametrically opposed drain ports 13. The advantage of this embodiment is that it allows for a uniform disposal of the sand media (or any other filtering media). Furthermore, it also allows for an easier disposal of the sand media as the media can be disposed on both sides of the tank. Additionally, this embodiment also allows for easier access to the underdrain 11 and its lateral sections 12. The drain ports may also be symmetrical around the vertical centerline of the vessel 1.

The interior of vessel 1 may be coated, creating a protective barrier between the vessel wall 10 and the liquid within the vessel. This further helps in preventing corrosion for the vessel 1. This coating, for example, may be Scotchkote™ 134. This is important in a stainless steel vessel because of corrosion pinhole leaks due to MIC as discussed earlier and electrolysis.

In reference to FIGS. 2 & 3, an inlet deflector 14 may be provided at the top of the vessel in order to create a uniform distribution of laminar flow across the vessel onto the media bed while avoiding channeling of the media bed. This allows uniform and efficient filtering of the liquid within the vessel.

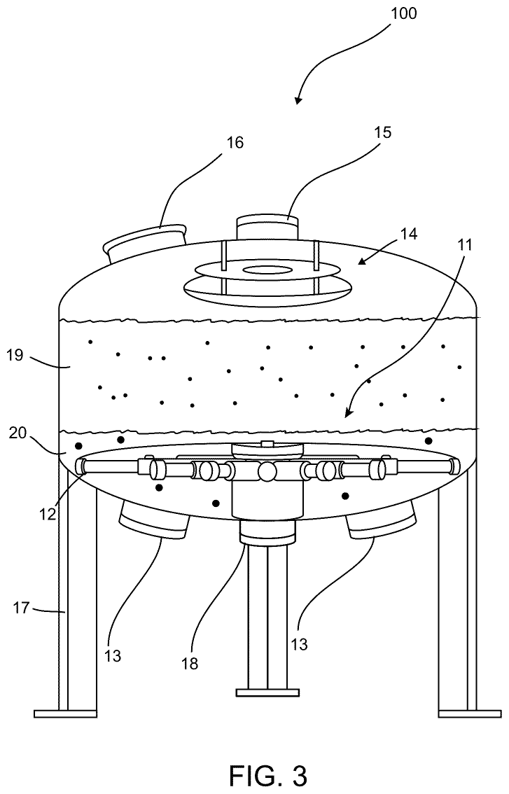

In reference to FIGS. 1-3, water (or other liquid required to be filtered) enters through the inlet 15 from a backwash valve (not shown). The water enters the vessel through the backwash valve and splashes onto the inlet deflector 14, creating a laminar flow. This laminar flow of water then flows through the filtration media bed (i.e sand). Upon exiting outlet 18 via the underdrain 11, the vessel the filtered water exits and is distributed for the desired use. During cleaning and/or inspection of the vessel, the media bed may be drained through the drain ports 13. The underdrain 11 and any additional interior maintenance (e.g. coating maintenance/inspection) on the vessel may also be done via access through these drain ports.

It should be known that one of ordinary skill in the art may make modifications to the invention and still achieve the same result of filtration without departing from the spirit and scope of the invention. These modifications may include drain port location, upper manway location, design of underdrain system, splash plate/deflector design.

1. A filtering system configured to filter liquid for external use comprising:
a vessel configured to hold a filtering media, said vessel having a wall defining an inner volume, wherein the vessel includes an inlet and an outlet;
a removable underdrain located on a lower section of the vessel;
wherein the underdrain is disposed within the inner volume and coupled to the outlet of the vessel; and
a pair of diametrically opposed drain ports configured for emptying the vessel of the filtering media and configured to provide access to the removable underdrain for replacement.

2. The filtering system of claim 1, wherein the underdrain further comprises laterals extending from a main body of the underdrain configured to uniformly drain the liquid out of the vessel.

3. The filtering system of claim 1, wherein the filtering media is sand.

4. The filtering system of claim 1, wherein the underdrain is disposed at the lowest part of the lower section.

5. The filtering system of claim 1, wherein the vessel is coated with a corrosion preventative barrier on its internal surface.

6. The filtering system of claim 1, wherein the vessel is suspended from a ground via at least one vessel support beam.

7. A filtering system configured to filter liquid for external use comprising:
a vessel having an upper, middle, and lower section;
said vessel configured to hold a filtering media and having a wall defining an inner volume, wherein the vessel includes an inlet at the upper section and an outlet at the lower section;
a removable underdrain located on the lower section of the vessel;
wherein the underdrain is disposed within the inner volume and coupled to the outlet of the vessel; and
at least one drain port configured for emptying the vessel of the filtering media and configured to provide access to the removable underdrain for replacement;
wherein the vessel is absent of a side manway at a middle section of the vessel.

8. The filtering system of claim 7, wherein the underdrain further comprises laterals extending from a main body of the underdrain configured to uniformly drain the liquid out of the vessel.

9. The filtering system of claim 7, wherein the filtering media is sand.

10. The filtering system of claim 7, wherein the underdrain is disposed at the lowest part of the lower section.

11. The filtering system of claim 7, wherein the vessel is coated with a corrosion preventative barrier on its internal surface.

12. The filtering system of claim 7, wherein the vessel is suspended from a ground via at least one vessel support beam.

13. The filtering system of claim 7, wherein the at least one drain port is two drain ports diametrically opposed relative to the vertical centerline of the vessel.

14. A filtering system configured to filter liquid for external use comprising:
a suspended vessel configured to hold a filtering media, said vessel having a wall defining an inner volume, wherein the vessel includes an inlet and an outlet;
wherein the vessel is configured to be suspended from a ground via at least one vessel support beam, and wherein the outlet is on the lowest section of the vessel at a centerline of the vessel;
a removable underdrain disposed within the inner volume and coupled to the outlet of the vessel; and
a pair of diametrically opposed drain ports configured for emptying the vessel of the filtering media and configured to provide access to the removable underdrain for replacement.

15. The filtering system of claim 14, wherein the underdrain further comprises laterals extending from a main body of the underdrain configured to uniformly drain the liquid out of the vessel.

16. The filtering system of claim 14, wherein the filtering media is sand.

17. The filtering system of claim 14, wherein the vessel is coated with a corrosion preventative barrier on its internal surface.

18. The filtering system of claim 14, wherein the vessel includes an upper manway at the upper section of the vessel.

19. The filtering system of claim 14, wherein the vessel is absent of a side manway at a middle section of the vessel.

20. The filtering system of claim 14, wherein a vessel's width is greater than a vessel's height.
